(19) United States
(12) Patent Application Publication
(10) Pub. No.: US 2025/0080467 A1
(43) Pub. Date: Mar. 6, 2025

(54) COMMUNICATION APPARATUS, COMMUNICATION METHOD, AND PROGRAM

(71) Applicant: NIPPON TELEGRAPH AND TELEPHONE CORPORATION, Tokyo (JP)

(72) Inventors: Katsuma MIYAMOTO, Tokyo (JP); Shinya KAWANO, Tokyo (JP); Hiroki KANO, Tokyo (JP); Koji SUGISONO, Tokyo (JP)

(21) Appl. No.: 18/725,950

(22) PCT Filed: Feb. 25, 2022
(86) PCT No.: PCT/JP2022/007918

§ 371 Date: Jul. 1, 2024

(51) Int. Cl. H04L 47/20; H04L 61/09

(52) U.S. Cl. CPC H04L 47/20; H04L 61/09

(57) ABSTRACT

A communication device that performs packet communication includes a data storage unit that holds a rule of a value-added service policy, a transmission unit that inquires to a translation device that performs address translation about translation information including information before the address translation, a reception unit that receives the translation information from the translation device, and a control unit that determines whether to apply the rule to a packet after the address translation received from the translation device by using the translation information.

### TECHNICAL FIELD

The present invention relates to a communication device that performs packet communication.

### BACKGROUND ART

A configuration in which packets transmitted from a terminal are transferred to an external server by a gateway (GW) is widely used as a communication form. The GW described above generally has a network address port translation (NAPT) function. The GW having the NAPT function is referred to as a NAT-GW. Note that the processing of NAPT may be referred to as “address translation”.

A GW that provides a value-added service (VAS) (referred to as a VAS-GW) such as packet filtering may be provided between a NAT-GW and an external server. The VAS-GW generally executes processing related to a value-added service based on a 5-tuple of packets.

### CITATION LIST

### Non Patent Literature

Non Patent Literature 1: Juniper NETWORKS, “Network Address Port Translation,” 17, Feb., 2021. https://www.juniper.net/documentation/us/en/software /junos/interfaces-adaptive-services/topics/topic-map/network-address-port-translation.html

### SUMMARY OF INVENTION

### Technical Problem

A rule of the value-added service policy held by the VAS-GW is described based on address information before address translation for packets. Therefore, the VAS-GW cannot determine whether to apply the rule of the value-added service policy to the packet subjected to address translation by the NAT-GW at the preceding stage.

The present invention has been made in view of the above points, and an object thereof is to provide a technology capable of appropriately applying a rule of a value-added service even in a case that a device that performs address translation is provided at a preceding stage to that of a device that provides the value-added service in packet communication.

### Solution to Problem

According to the disclosed technology, a communication device that performs packet communication is provided, the communication device including
a data storage unit that holds a rule of a value-added service policy,
a transmission unit that inquires to a translation device that performs address translation about translation information including information before the address translation,
a reception unit that receives the translation information from the translation device, and
a control unit that determines whether to apply the rule to a packet after the address translation received from the translation device by using the translation information.

### Advantageous Effects of Invention

According to the disclosed technology, there is provided a technology capable of appropriately applying a rule of a value-added service even in a case that a device that performs address translation is provided at a preceding stage of a device that provides the value-added service in packet communication.

### BRIEF DESCRIPTION OF DRAWINGS

FIG. 1 is a diagram illustrating a basic system configuration.

FIG. 2 is a diagram for describing the problem.

FIG. 3 is a diagram for describing an overview of an embodiment.

FIG. 4 is a diagram for describing method 1.

FIG. 5 is a diagram for describing method 2.

FIG. 6 is a diagram for describing method 3.

FIG. 7 is a diagram for describing a configuration example of a communication device.

FIG. 8 is a diagram illustrating a hardware configuration example of a device.

### DESCRIPTION OF EMBODIMENTS

Hereinafter, an embodiment of the present invention (present embodiment) will be described with reference to the drawings. The embodiment described below is merely an example, and embodiments to which the present invention is applied are not limited to the following embodiment.

### (Basic Configuration)

First, a configuration and an operation of a basic system related to the present embodiment will be described, and then the problem will be described.

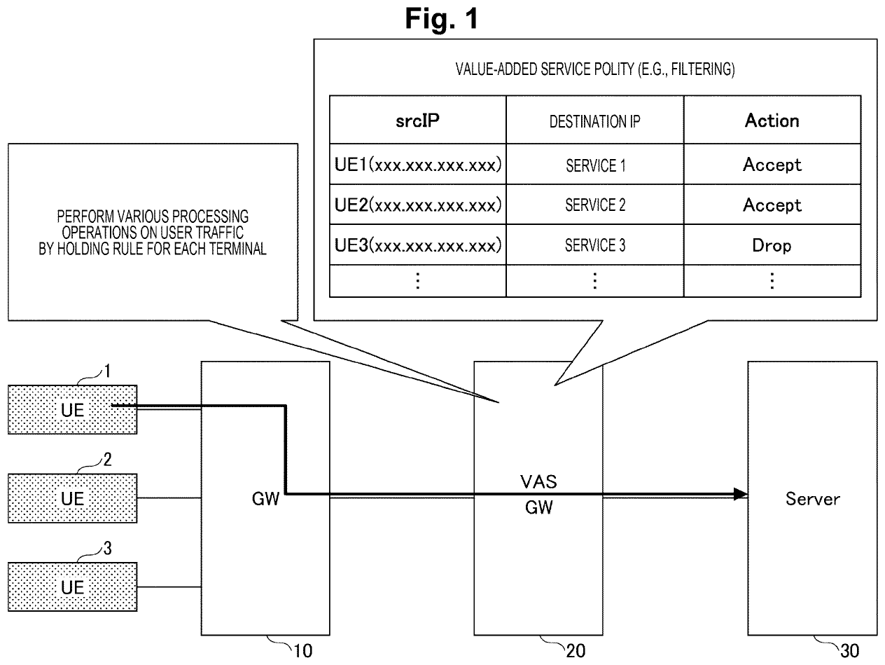

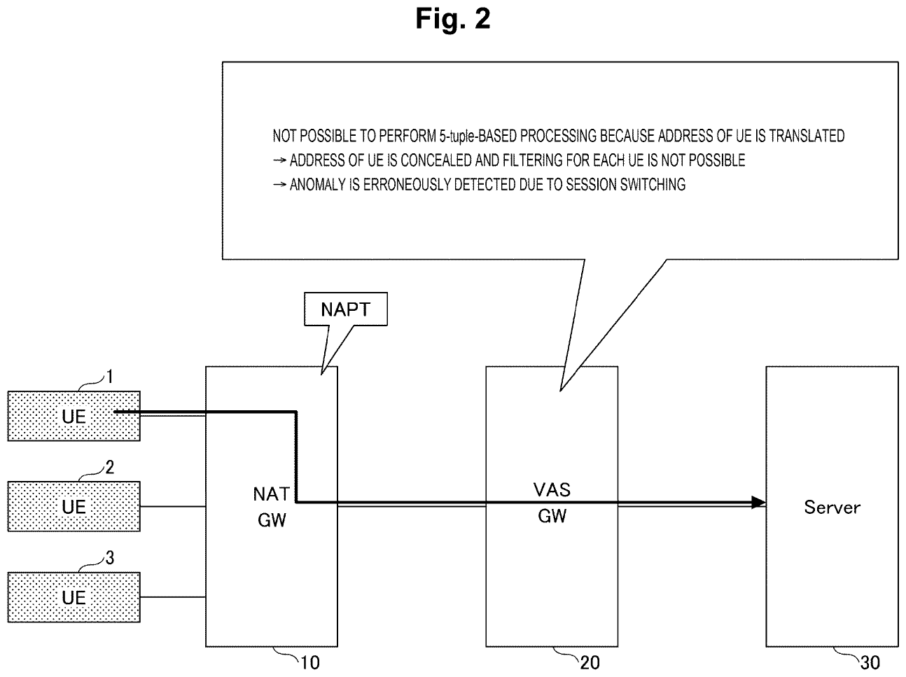

FIG. 1 illustrates a configuration example of a system. FIG. 1 (and FIG. 2) illustrates an example of a configuration not including a function according to the present invention in order to describe the problem. Note that FIGS. 1 and 2 are not publicly known drawings.

As illustrated in FIG. 1, the present system includes a GW 10, a value-added service-gateway (VAS-GW) 20, and a server 30, and user equipments (UE) 1 to 3 are connected to the GW 10. Furthermore, the devices are connected by a wired or wireless network, and can communicate with each other as illustrated in the drawing.

The UEs are devices that make and receive packet communications. The UEs are, for example, PCs, smartphones, IoT devices, or the like. Each UE may be referred to as a terminal.

The GW 10 may be any device as long as it is a network device that processes packets. The GW 10 has network functions such as L2/L3 transfer, a firewall, VPN connection, DPI, and proxy. The GW 10 may be referred to as a communication device.

The GW 10 may be an S-GW or a P-GW in the EPC, a UPF in 5GC, a base station (eNodeB, gNodeB, or the like), a router, a switch, or the like. Furthermore, the GW 10 may be a physical device or a virtual device.

The details given regarding the GW 10 also apply to the VAS-GW 20. The VAS-GW 20 is different from the GW 10 in that the former has a function of providing a value-added service.

In FIG. 1, the UEs 1 to 3 are connected to the GW 10 and communicate with a server 30 connected to the end thereof. The server 30 is, for example, an application server. The VAS-GW 20 is installed between the GW 10 and the server 30. The VAS-GW 20 provides a value-added service described below, for example, for user communication.
Packet filtering
QoS control (prioritizing communication from specific UE/specific port, etc.)
Detection of anomaly in communication
Policy-based routing

In the processing operations, the VAS-GW 20 looks at the packet header (5-tuple or the like) of a received packet and determines whether the packet needs to be processed. 5-tuple includes transmission source IP address, transmission source port number, destination IP address, destination port number, and protocol number.

As an example, the VAS-GW 20 holds a value-added service policy (table) for filtering as illustrated in FIG. 1. As indicated in the value-added service policy, various kinds of processing can be performed on user traffic by having rules for each UE in the value-added service policy.

### (Regarding Problems)

For example, in a configuration in which a large number of UEs are connected, by performing network address port translation (NAPT) in the GW 10 (here, the NAT-GW 10), concealment of the address of the UEs and saving of the global IP addresses can be realized as illustrated in FIG. 2. Note that the processing of NAPT may be referred to as address translation. In addition, “NAPT” also includes an operation of performing only address translation without performing port number translation.

However, when NAPT processing is performed by the NAT-GW 10 (a router or the like) at the preceding stage of the VAS-GW 20, the VAS-GW 20 receives packets in which 5-tuple of the UE has been translated from the NAT-GW 10, and thus, the UE cannot be identified and the value-added service cannot be correctly operated. Specifically, for example, there is a possibility that the address of the UE is concealed and filtering cannot be performed for each UE, or an anomaly is erroneously detected due to session switching as illustrated in FIG. 2.

In an existing technology, a general router (GW) has a function of statically specifying a translation rule, and thus the translation rule can be set in advance. However, because the number of addresses and sessions of UEs dynamically increase or decrease, a problem such as running out of port numbers is assumed.

### (Regarding Technology of Embodiment)

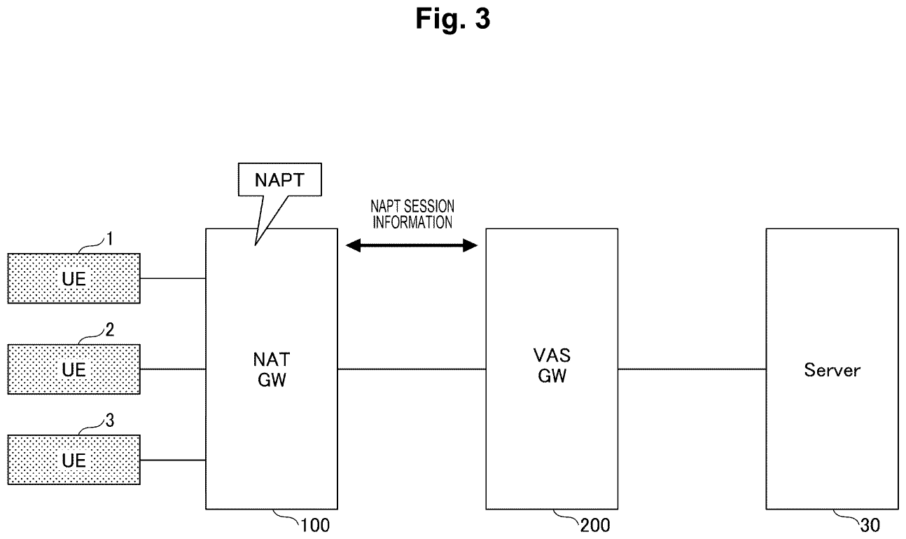

Hereinafter, the technology according to the present embodiment will be described. FIG. 3 illustrates a system configuration example according to the present embodiment. The system configuration illustrated in FIG. 3 is basically the same as the configuration illustrated in FIG. 1 or 2. A NAT-GW 100 and a VAS-GW 200 correspond to the GWs described in FIGS. 1 and 2 to which the function according to the present invention has been added.

The NAT-GW 100 may be referred to as a translation device, and the VAS-GW 200 may be referred to as a value-added service providing device. In addition, both the NAT-GW 100 and the VAS-GW 200 may be referred to as a communication device.

Note that the NAT-GW 100 that provides notification of session information may be any device as long as it is capable of recognizing a session state related to NAT translation, such as a radius server, a DHCP server, or a 4G/5G core function unit (SMF, AMF, etc.), in addition to an S-GW, a P-GW, a UPF, a base station, a router, a switch, or the like as described above. The NAT-GW 100 may be a home gateway for household use, a CPE, or the like.

In the system according to the present embodiment, the VAS-GW 200 identifies information of the UE by acquiring the session information of NAPT from the NAT-GW 200.

Note that, when the NAT-GW 100 holds a translation rule such as an IP address/port number as an NAPT rule, and communication that matches the NAPT rule takes place, a session of the NAPT is generated, and the IP address and the port number of the communication that matches the session are translated. The information about the session is session information. The session information may be referred to as translation information.

In the present embodiment, by sharing the session information between the VAS-GW 200 and the NAT-GW 100, the VAS-GW 200 can perform packet processing related to the value-added service based on the information before translation.

The session information passed from the NAT-GW 100 to the VAS-GW 200 is, for example, “5-tuple before translation and 5-tuple after translation”. Furthermore, the session information may be “a part of 5-tuple before translation and a part of 5-tuple after translation”. Furthermore, the session information may be “5-tuple before translation” or “a part of 5-tuple before translation”.

Specifically, the session information passed from the NAT-GW 100 to the VAS-GW 200 may be “the transmission source IP address and the transmission source port number before translation and the transmission source IP address and the transmission source port number after translation” or “the transmission source IP address and the transmission source port number before translation”.

As a variation of the method for passing the session information from the NAT-GW 100 to the VAS-GW 200, there are the following three methods.

Method 1 (pull type): When the VAS-GW 200 receives a new 5-tuple packet from the NAT-GW 100, the VAS-GW 200 inquires to the NAT-GW 100 about the session information.

Method 2 (push type): The NAT-GW 100 notifies the VAS-GW 200 of the session information after the translation each time the NAPT translation is performed.

Method 3 (header-embedded type): The NAT-GW 100 embeds the IP address and the port number before translation in the option header of the IP header, and transmits the packet.

Hereinafter, each of the methods will be described in more detail.

### (Method 1: Pull Type)

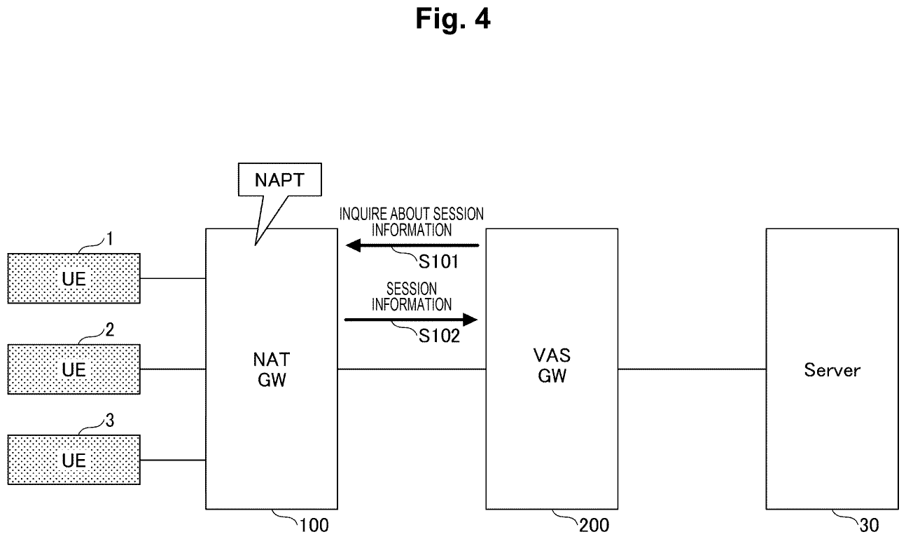

The processing procedure of method 1 will be described with reference to FIG. 4. It is assumed that the VAS-GW 200 receives a packet of a new session from the NAT-GW 100.

In S101, the VAS-GW 200 inquires to the NAT-GW 100 about the session information. Inquiring about the session information may be transmitting a request for the session information.

In S102, the NAT-GW 100 transmits the session information to the VAS-GW 200. The VAS-GW 200 receives the session information.

Here, it is assumed that 5-tuple after address translation of an old session before a new session starts is “a transmission source IP address, a transmission source port number, a destination IP number, a destination port number, and a protocol number” which is “A, B, C, D, and E”.

When the VAS-GW 200 receives, for example, a packet whose 5-tuple is “A, B, X, Y, and E” as a packet of a new session from the NAT-GW 100, the VAS-GW 200 inquires to the NAT-GW 100 about session information of “A, B, X, Y, and E”.

In response to this inquiry, the NAT-GW 100 returns, for example, information indicating that 5-tuple before NAPT translation of “A, B, X, Y, and E” is “A′, B′, X, Y, and E” to the VAS-GW 200 as session information. Thereby, the VAS-GW 200 can perform filtering, for example, using the filtering rule whose transmission source IP address is “A′”, for the session of “A, B, X, Y, and E”.

In method 1, although the VAS-GW 200 may make an inquiry in all new sessions, in this case, there is a possibility that the processing amount of the NAT-GW 100 increases.

Therefore, the VAS-GW 200 may make an inquiry only “when a packet of a new session is received” and “the session is communication related to the policy of the VAS”. As a result, unnecessary inquiries can be prevented.

Regarding determining whether the session is communication related to the policy of the VAS, for example, the VAS-GW 200 can compare 5-tuple of the session with the held VAS policy (table information) and determine that the session is communication related to the policy of the VAS when at least one piece of information that matches the VAS policy is in the 5-tuple.

In addition, in method 1, the packet is transmitted from the NAT-GW 100 to the VAS-GW 200 even during processing of the inquiry of the session information. The VAS-GW 200 holds the packet received during the processing of the inquiry of the session information in the buffer, and processes the packet held in the buffer after acquiring the session information.

Regarding the buffer holding of the received packet during the processing of the inquiry of the session information, the VAS-GW 200 desirably holds the packet in the buffer at the time of three-way handshake in TCP. This is because, data transmission is started by the established connection after the three-way handshake of in TCP, and thus, there is a possibility that buffer overflow occurs due to a large number of packets from the UE in processing of an inquiry. By holding the packet in the buffer at the time of three-way handshake in TCP, buffer overflow can be prevented.

### (Method 2: Push Type)

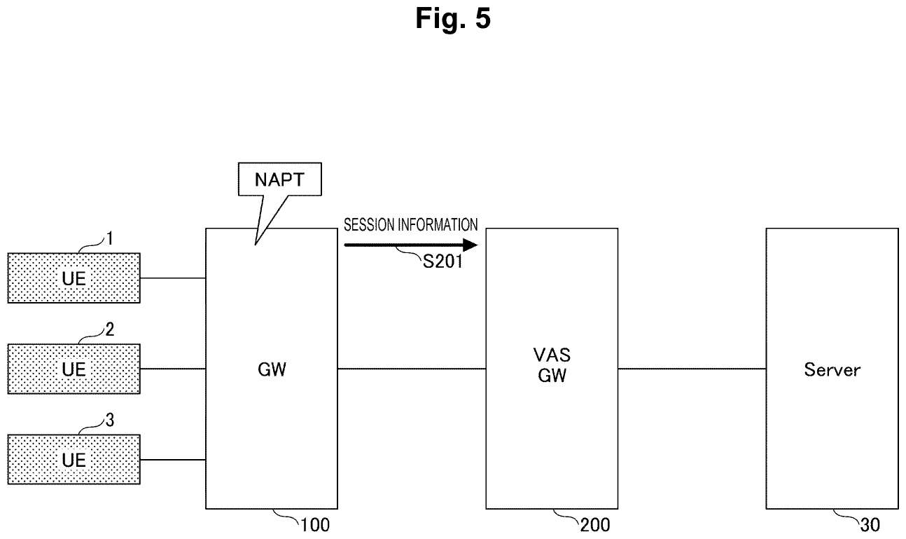

Processing of method 2 will be described with reference to FIG. 5. The NAT-GW 100 performs NAPT translation on the packet received from the UE, and notifies the VAS-GW 200 of the session information in S201 immediately before transferring the packet after NAPT translation to the VAS-GW 200.

As an example, it is assumed that the NAT-GW 100 receives a packet whose 5-tuple is “A′, B′, C, D, and E” from the UE and translates “A′, B′, C, D, and E” into “A, B, C, D, and E” by NAPT translation. At this time, before transferring the packet, the NAT-GW 100 transmits information indicating that “A′, B′, C, D, and E” is data before translation of “A, B, C, D, and E” to the VAS-GW 200 as session information. Thereafter, the NAT-GW 100 transmits the packet of “A, B, C, D, and E” in the session to the VAS-GW 200.

The VAS-GW 200 can perform filtering, for example, using the filtering rule whose transmission source IP address is “A′”, for the packet of “A, B, C, D, and E” based on the session information received from the NAT-GW 100.

The transmission of the session information from the NAT-GW 100 to the VAS-GW 200 may be performed only at the time of the first packet transmission of a certain session. Thereafter, in a period in which the session continues, the VAS-GW 200 can perform application determination of the value-added service policy using the session information. In method 2, since there is no inquiry, a communication delay can be made shorter than that in method 1.

### (Method 3: Header-Embedded Type)

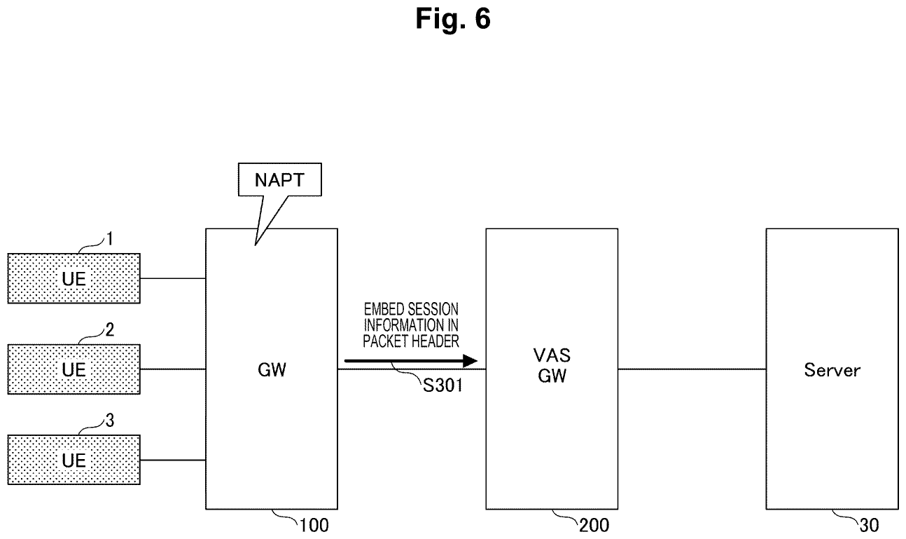

Processing of method 3 will be described with reference to FIG. 6. The NAT-GW 100 performs NAPT translation on the packet received from the UE. Here, as an example, it is assumed that translation is performed on a set (IP address/port number) of the IP address of a transmission source of a packet and a port number of the transmission source.

The NAT-GW 100 embeds the IP address/port number before translation in the IP header (specifically, the option header) of the packet after translation, and transmits the packet after translation in which the IP address/port number before translation is embedded to the VAS-GW 200 in S301.

As an example, it is assumed that the NAT-GW 100 receives a packet whose 5-tuple is “A′, B′, C, D, and E” from the UE and translates “A′, B′, C, D, and E” into “A, B, C, D, and E” by NAPT translation.

At this time, the NAT-GW 100 embeds “A′, B′” in packet after the NAPT translation, and transmits the packet in which “A′, B′” has been embedded to the VAS-GW 200. The VAS-GW 200 can perform filtering, for example, using the filtering rule whose transmission source IP address is “A′”, for the packet of “A, B, C, D, and E” based on “A′, B′” embedded in the packet received from the NAT-GW 100.

In a certain session, the packet in which the IP address/port number before translation is to be embedded may be only the first packet of the session or may be all packets in subsequent communication in the session. In addition, the VAS-GW 200 may delete the option header in which the information before translation has been embedded. As a result, the UE of the transmission source can be concealed.

### (Device Configuration Example)

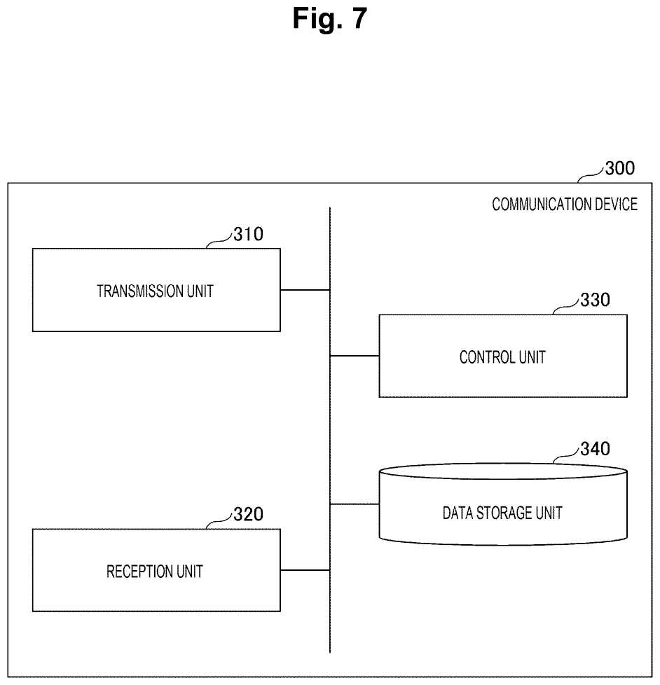

FIG. 7 is a configuration diagram illustrating a functional configuration of a communication device 300 corresponding to the NAT-GW 100 or the VAS-GW 200.

As illustrated in FIG. 7, the communication device 300 includes a transmission unit 310 that performs packet transmission, a reception unit 320 that performs packet reception, a control unit 330 that performs processing and the like on a packet, and a data storage unit 340 that stores various data.

When the communication device 300 operates as the VAS-GW 200 of method 1, the data storage unit 340 stores the rule of the value-added service policy. The transmission unit 310 inquires to the NAT-GW 100 about translation information including information before address translation, and the reception unit 320 receives the translation information from the NAT-GW 100. The control unit 330 determines whether to apply the rule of the value-added service policy to the packet after address translation received from the NAT-GW 100 by using the translation information.

When the communication device 300 operates as the NAT-GW 100 of method 2, the control unit 330 performs address translation on the received packet and generates translation information including the information before the address translation. The transmission unit 310 transmits the translation information to the VAS-GW 200, and transmits the packet after the address translation to the VAS-GW 200 after transmitting the translation information.

When the communication device 300 operates as the NAT-GW 100 of method 3, the control unit 330 performs address translation on the received packet and embeds translation information including the information before the address translation into the packet after the address translation. The transmission unit 310 transmits the packet in which the translation information has been embedded to the VAS-GW 200.

### (Hardware Configuration Example)

The communication device 300 corresponding to the NAT-GW 100 or the VAS-GW 200 can be implemented using, for example, a dedicated hardware circuit, or can be implemented by causing a computer to execute a program. This computer may be a physical computer, or may be a virtual machine on a cloud.

That is, the communication device 300 can be realized by a program corresponding to processing performed by the communication device 300 executed by use of hardware resources such as a CPU and a memory built in the computer. The above program can be stored and distributed by being recorded in a computer-readable recording medium (portable memory or the like). Also, the program can be provided through a network such as the Internet or an electronic mail.

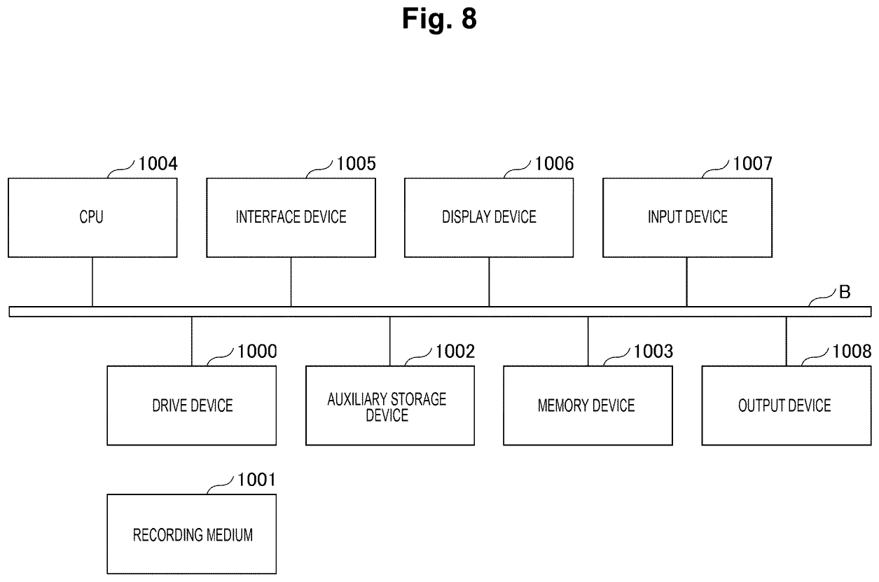

FIG. 8 is a diagram illustrating a hardware configuration example of the above computer. The computer in FIG. 8 includes a drive device 1000, an auxiliary storage device 1002, a memory device 1003, a CPU 1004, an interface device 1005, a display device 1006, an input device 1007, an output device 1008, and the like, which are connected to each other via a bus BS.

The program for performing processes in the computer is provided through a recording medium 1001 such as a CD-ROM or a memory card, for example. When the recording medium 1001 storing the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program, and also stores necessary files, data, and the like.

When an instruction to start the program is made, the memory device 1003 reads the program from the auxiliary storage device 1002 and stores the program. The CPU 1004 realizes a function related to the communication device 300 in accordance with the program stored in the memory device 1003. The interface device 1005 is used as an interface for connection to a network. The display device 1006 displays a graphical user interface (GUI) or the like according to the program. The input device 1007 includes a keyboard and a mouse, buttons, a touch panel, or the like, and is used to input various operation instructions. The output device 1008 outputs a calculation result.

### (Effects of Embodiments)

According to the technology of the present embodiment, a rule related to a value-added service can be appropriately applied even in a case that a device that performs address translation is provided at a preceding stage of a device that provides the value-added service in packet communication.

### (Supplementary Notes)

Regarding the above embodiment, the following supplementary notes are further disclosed.

### (Supplementary Note 1)

A communication device including
a memory configured to hold a rule of a value-added service policy; and
at least one processor connected to the memory, in which
the processor
inquires to a translation device that performs address translation about translation information including information before address translation,
receives the translation information from the translation device, and
determines whether to apply the rule to a packet after the address translation received from the translation device by using the translation information.

### (Supplementary Note 2)

A communication device including
a memory, and
at least one processor connected to the memory, in which
the processor
performs address translation on the received packet and generates translation information including information before the address translation, and
transmits the translation information to a value-added service providing device that provides a value-added service by using information before the address translation, and transmits the packet after the address translation to the value-added service providing device after transmitting the translation information.

### (Supplementary Note 3)

A communication device including
a memory, and
at least one processor connected to the memory, in which
the processor
performs address translation on a received packet and embeds translation information including information before the address translation into the packet after the address translation, and
transmits the packet in which the translation information is embedded to a value-added service providing device that provides a value-added service by using information before the address translation.

### (Supplementary Note 4)

A communication method performed by a computer functioning as a communication device configured to include a data storage unit holding a rule of a value-added service policy and perform packet communication, the communication method including:
a step of inquiring to a translation device that performs address translation about translation information including information before address translation,
a step of receiving the translation information from the translation device, and
a step of determining whether to apply the rule to a packet after the address translation received from the translation device by using the translation information.

### (Supplementary Note 5)

A communication method performed by a computer functioning as a communication device configured to perform packet communication, the communication method including
a step of performing address translation on a received packet and generating translation information including information before the address translation, and
a step of transmitting the translation information to a value-added service providing device that provides a value-added service by using information before the address translation, and transmitting the packet after the address translation to the value-added service providing device after transmitting the translation information.

### (Supplementary Note 6)

A communication method performed by a computer functioning as a communication device configured to perform packet communication, the communication method including
a step of performing address translation on a received packet and embedding translation information including information before the address translation in the packet after the address translation, and
a step of transmitting the packet in which the translation information is embedded to a value-added service providing device that provides a value-added service by using the information before the address translation.

### (Supplementary Note 7)

A non-transitory storage medium storing a program for causing a computer to perform each processing operation in the communication device according to any one of supplementary notes 1 to 3.

Although the present embodiment has been described above, the present invention is not limited to such a specific embodiment, and various modifications and changes can be made within the scope of the present invention disclosed in the claims.

### REFERENCE SIGNS LIST

1 to 3 UE
10 GW
100 NAT-GW
20, 200 VAS-GW
30 Server
300 Communication device
310 Transmission unit
320 Reception unit
330 Control unit
340 Data storage unit
1000 Drive device
1001 Recording medium
1002 Auxiliary storage device
1003 Memory device
1004 CPU
1005 Interface device
1006 Display device
1007 Input device
1008 Output device

1. A communication device configured to perform packet communication, the communication device comprising:
a processor; and
a memory storing program instructions that cause the processor to:
hold a rule of a value-added service policy;
inquire to a translation device configured to perform address translation about translation information including information before the address translation;
receive the translation information from the translation device; and
determine whether to apply the rule to a packet after the address translation received from the translation device by using the translation information.

2. A communication device configured to perform packet communication, the communication device comprising:
a processor; and
a memory storing program instructions that cause the processor to:
perform address translation on a received packet and generate translation information including information before the address translation; and
transmit the translation information to a value-added service providing device that provides a value-added service by using information before the address translation, and transmit the packet after the address translation to the value-added service providing device after transmitting the translation information.

3. (canceled)

4. A communication method performed by a communication device configured to include a data storage unit holding a rule of a value-added service policy and perform packet communication, the communication method comprising:
inquiring to a translation device that performs address translation about translation information including information before address translation;
receiving the translation information from the translation device; and
determining whether to apply the rule to a packet after the address translation received from the translation device by using the translation information.

5-6. (canceled)

7. A non-transitory computer-readable recording medium having stored therein a program for causing a computer to perform the communication method according to claim 4.
